(19) United States
(12) Patent Application Publication
(10) Pub. No.: US 2017/0273407 A1
(43) Pub. Date: Sep. 28, 2017

(54) COMPOSITIONS AND METHODS FOR MANUFACTURING FOOTWEAR STIFFENERS

(71) Applicant: Stanbee Company, Inc., Carlstadt, NJ (US)

(72) Inventor: Bruce Goldberg, Clifton, NJ (US)

(21) Appl. No.: 15/467,050

(22) Filed: Mar. 23, 2017

Related U.S. Application Data
(60) Provisional application No. 62/312,605, filed on Mar. 24, 2016.

(51) Int. Cl. A43B 23/17; B32B 37/00; B32B 27/40; B32B 37/12; B32B 7/12; B32B 27/06

(52) U.S. Cl. CPC A43B 23/17; B32B 7/12; B32B 27/06; B32B 27/40; B32B 37/12; B32B 37/156; B32B 2437/02

(57) ABSTRACT

The present invention relates to a process for preparing and compositions for stiffening materials for use in the manufacturing of footwear using a combination of stiffeners and adhesives.

### CROSS-REFERENCE TO RELATED APPLICATIONS

This disclosure claims the benefit of priority to U.S. Provisional Patent Application No. 62/312605, filed 24 Mar., 2016, which is incorporated herein in its entirety.

### FIELD OF THE INVENTION

The invention relates to stiffeners, such as the stiffeners used in the manufacture of shoes to retain the shape of heel and toe portions of the footwear.

### BACKGROUND

There are a number of different types of stiffeners used in the shoe industry. U.S. Pat. Nos. 3,523,103; 3,590,411; 3,647,616; 3,891,785; 3,973,285; 4,814,037; 6,391,380 and 6,475,619 disclose methods and materials for improving the stiffness and adhesive qualities of materials for use in the footwear industry (all of which are incorporated by referenced). The stiffening plastic resins are selected from styrene butadiene, polystyrene, polyvinylacetate, acrylic as well as other polymer lattices that may be saturated into a needle punch nonwoven fabric. Some of these types of stiffeners have hot melt adhesives coated onto their surfaces and are heat activated to bond to the shoe upper and lining. Some are activated with solvents and do not have heat activated hot melt adhesives. A second group of stiffeners are premolded materials made from polyvinylchloride, ionomers or thermoplastic rubbers (TPR). These premolded stiffeners require an adhesive to be painted on the surface for bonding to the shoe components. There are stiffeners that are made via extrusion of a resin such as an ionomer or other thermoplastic polymers and then require an extrusion coating of an adhesive onto the polymer sheet. The last category comprises stiffeners that are made from powders that are admixtures of a filler or hard material with an adhesive or softer material. These polymer powder blends are then heat sintered to produce a stiffener.

The ideal characteristic of the stiffener is to have high resiliency and good stiffness for a given weight of material. The saturated stiffeners can be made stiff but usually the stiffer grades do not have high resiliency. The saturated stiffeners, the premolded stiffeners and the extruded stiffeners all require an extra processing step to have an adhesive applied to the surface. The powder coated stiffeners usually involve a need for cryogrinding to be able to create a fine powder from a low melting point adhesive which results in added costs as well as a need for a critical particle size distribution. The powder coated materials, since they are sintered, are also less tough or strong and need extra weight for a given level of stiffness since the sintering action does not form a true melt of the material to maximize the physical properties. These materials also need high levels of the adhesive component in order to get good bonding to the various substrates that they will be attached to. This adds additional cost and additional weight. When hot melting the saturated materials or the extruded materials they need a significant amount of hot melt adhesive to be coated onto their surfaces in a separate step.

There are processes and products that are used in the packaging industry where a tie layer of adhesive is added to another resin to produce a very thin layer to bond these various layers together. Usually this is done with adhesive tie layers in which the adhesive component is similar in melt viscosity and melting point to the other layers. The process to produce these materials is an extrusion process that uses multiple extruders and either a multicomponent die block or a manifold die.

### SUMMARY

A first embodiment is a footwear stiffener that includes an adhesive layer coextruded with a stiffener core. The adhesive layer consisting essentially of a low melting point plastic adhesive resin and less than about 5 wt. % of an antiblocking agent, and the stiffener core comprising an admixture of a stiffening plastic resin and about 2 wt. % to about 15 wt. % of the low melting point plastic adhesive resin.

A second embodiment is footwear stiffener that includes an adhesive layer coextruded with and carried on a stiffener core. The footwear stiffener including about 10 wt. % to about 30 wt. % of the adhesive layer; the adhesive layer comprising a low melting point plastic adhesive resin and less than about 5 wt. % of an antiblocking agent. The footwear stiffener further includes the stiffener core which includes an admixture of a stiffening plastic resin and a footwear stiffener recycle. The stiffener core includes about 2 wt. % to about 30 wt. % of the low melting point plastic adhesive resin

A third embodiment is a footwear stiffener that includes an adhesive layer coextruded with and carried on a stiffener core. The footwear stiffener including about 10 wt. % to about 30 wt. % of the adhesive layer; the adhesive layer including a polyurethane having a melting point less than about 85° C., and 0 wt. % to about 5 wt. % of an antiblocking agent. The stiffener core comprising an extrusion of an admixture of a polycyclohexylenedimethylene terephthalate copolymer; and a footwear stiffener recycle. The footwear stiffener recycle includes about 10 wt. % to about 30 wt. % of the polyurethane having a melting point less than about 85° C., about 25 wt. % to about 70 wt. % of the polycyclohexylenedimethylene terephthalate copolymer. The stiffener core includes about 2 wt. % to about 30 wt. % of the low melting point plastic adhesive resin.

A fourth embodiment is a process of manufacturing a footwear stiffener. The process can include, first, providing an core extruder with a mixture of about 40 wt. % to about 60 wt. % of a scrap polyester and about 40 wt. % to about 60 wt. % of a scrap stiffener core that comprises about 5 wt. % to about 20 wt. % of a thermoplastic polyurethane and about 80 wt. % to about 95 wt. % of a copolyester; the scrap stiffener core comprising a layer of the thermoplastic polyurethane carried on the copolyester; and providing an adhesive extruder with a low melting point plastic adhesive resin. The process can further include extruding a layer of a recycled stiffener core from the core extruder, and extruding a layer of a the low melting point plastic adhesive resin. Furthermore, the process can include contacting the layer of the recycled stiffener core and the layer of the low melting point plastic adhesive resin to form a recycled layered stiffener material; and then calendaring the recycled layered stiffener material.

A fifth embodiment is a process of manufacturing a footwear stiffener that includes providing an stiffener core extruder with about 40 wt. % to about 60 wt. % of a stiffening plastic resin and about 20 wt. % to about 50 wt. % of a footwear stiffener recycle that includes about 10 wt. % to about 30 wt. % of a low melting point thermoplastic polyurethane and about 25 wt. % to about 70 wt. % of the stiffening plastic resin. Providing an adhesive extruder with the low melting point thermoplastic polyurethane. Extruding a layer of a stiffener core from the stiffener core extruder and extruding a layer of an adhesive from the adhesive extruder. Contacting the stiffener core layer and the adhesive to form a layered stiffener material; and then calendaring the layered stiffener material.

### DETAILED DESCRIPTION

Detailed herein is a new composition for a footwear stiffener. This footwear stiffener includes an adhesive layer coextruded with and carried on a stiffener core; preferably a plurality of adhesive layers coextruded with the stiffener core. Herein, coextruded means that the two materials, the adhesive layer and the stiffener core, were contemporaneously extruded and impinged upon each other. The term coextruded does not mean that the two materials were admixed within a single extruder and processes to provide a homogeneous blend. Notably, the footwear stiffener does not have a homogeneous cross-sectional composition (from a sheet's first major surface to a second major surface); the cross-sectional composition of the foot wear-stiffener includes an external surface that includes, consists essentially of, or consists of the adhesive layer; then as progressing into the material from the external surface, the percentage of the composition that is the same as the adhesive layer decreases and the percentage of the composition that is the same as the stiffener core increases.

Preferably, the footwear stiffener includes a continuous, non-zero, concentration of the low melting point plastic adhesive resin from a first major surface carried by the adhesive layer through the stiffener core to a second major surface. Even more preferably, the footwear stiffener can include a continuous concentration of the low melting point plastic adhesive resin which is greater than about 2 wt. %.

In one instance, the adhesive layer includes, consisting essentially of, or consist of a low melting point plastic adhesive resin and less than about 5 wt. % of an antiblocking agent. In one example, the adhesive layer includes a plurality of low melting point plastic adhesive resins. In another example, the adhesive layer consists of a plurality of low melting point plastic adhesive resins and less than about 5 wt. % of an antiblocking agent, preferably two low melting point plastic adhesive resins. The (or each) low melting point plastic adhesive resin is, preferably, selected from those thermoplastic resins that have a melting point that is less than about 85° C., 80° C., 75° C., or 70° C. In one instance, the low melting point plastic adhesive resin can be a polyurethane; preferably, the low melting point plastic adhesive resin is a low melting point thermoplastic polyurethane. In another instance, the low melting point plastic adhesive resin can be selected from a polyester thermoplastic polyurethane, a polyether thermoplastic polyurethane, and a polycaprolactone thermoplastic polyurethane. In one preferable instance, the low melting point plastic adhesive resin is a polycaprolactone thermoplastic polyurethane. Additional, the or a low melting point plastic adhesive resin can be ethylene methyl acrylate copolymer, sold commercially as 2260 EMAC by Eastman Chemicals. 2260 EMAC has a melting point of 76° C. EMAC 2260 is ethylene methyl acrylate copolymer with a melt index of 2.1 g/10 min., a density of 944 kg/m³, a vicat softening temperature of 50° C., a brittleness temperature of <−73° C., a durometer hardness (Shore D Scale) of 37, a methyl acrylate content of 24%, a tensile stress at break (500 mm/min) of 11 Mpa, and an elongation at break (500 mm/min) of 835%, and a melting point of 76-77° C.

In another instance, the stiffener core includes, consists essentially of, or consist of an admixture of a stiffening plastic resin and a footwear stiffener recycle. The stiffener core further includes about 2 wt. % to about 30 wt. % of the low melting point plastic adhesive resin, preferably the same low melting point plastic adhesive resin utilized in the adhesive layer. In an alternative example, the low melting point plastic adhesive resin in the stiffener core can be distinct from the low melting point plastic adhesive resin utilized in the adhesive layer. In another example, the stiffener core includes, consists essentially of, or consist of an admixture of the stiffening plastic resin, the footwear stiffener recycle, a high melting point polyurethane, and an elastomer and/or a low melting point polyurethane; preferably, wherein the stiffener core composition features the low melting point polyurethane, included by being part of the footwear stiffener recycle.

The stiffener plastic resin can be selected from a polyethylene terephthalate, a styrene, styrene-butadiene, a vinyl acetate, a vinyl chloride, an acrylic, a polyvinyl chloride, a polyethylene, a polypropylene, a polyester, a polystyrene, a copolymer thereof, and a mixture thereof. The stiffener plastic can alternatively be a polycyclohexylenedimethylene terephthalate copolymer. Preferably, the stiffener plastic resin is a thermoplastic resin that have a softening point greater than about 70° C., 75° C., 80° C., 85° C., 90° C., 95° C., or 100° C. Further examples of the stiffener plastic resin can include extruded thermoplastic or powder coated thermoplastic materials which may be selected from the group consisting of polyvinyl chloride, ionomers, high, medium or low density polyethylene, polypropylene, polyesters, polystyrene and copolymers and compatible blends of such polymers. Examples of resins applicable herein as a stiffening plastic resin includes PETG, PET and copolyesters, such as, but not limited to, GP001 polyester (available from Eastman Chemicals). GP001 is a copolyester with a vicat softening temperature of 74° C. and a glass transition temperature of 75° C. At a thickness of 10 mils, a film of GP001 copolyester exhibited a density of 1.30 g/m³, an Elmendorf tear resistance of 7.5 N (M.D. and T.D.), a PPT tear resistance of 61 (M.D.) and 66N (T.D.), a tensile strength at break of 53 Mpa (7600 psi at M.D. and T.D.), a tensile modulus of (M.D.) 1570 Mpa (2.3×10⁵ psi) and (T.D.) 1560 (2.3×10⁵ psi), a dart impact at 23° C. of 355 g, an elongation at break of 5% (M.D. and T.D.), a Tear Propagation Resistance, Split Tear Method (at 254 mm/min) (M.D. and T.D.) of 15.7N. The GP001 Mechanical properties for injection molding are as follows, tensile stress at break of 3200 psi, tensile stress at yield of 7400 psi, and elongation at break of 184%, a tensile modulus of 3.3×10⁵ psi, a flexural yield strength of 10600 psi. In one instance, the stiffener plastic resin is (Eastman Chemical) Eastar 6763, which has a softening point of 85° C. (185° F.) and is usually extruded into a film at extrusion temperatures of 246-274° C. (475-525° F.).

In another example, the stiffener plastic resin includes a polyethylene terephthalate glycol copolyester. Preferably, the polyethylene terephthalate glycol copolyester is a recycled copolyester. More preferably, the polyethylene terephthalate glycol copolyester is a post-industrial recycled copolyester. In one instance, the post-industrial recycled copolyester is cuttings from the manufacture of a footwear stiffener.

The footwear stiffener recycle is, preferably, industrial/preconsumer scrap footwear stiffener produced by the methods disclosed herein. In one instance, the footwear stiffener recycle includes about 10 wt. % to about 30 wt. % of an adhesive layer which includes the low melting point plastic adhesive resin and less than about 5 wt. % of the antiblocking agent; and about 70 wt. % to about 90 wt. % of a recycle stiffener core. The recycle stiffener core, preferably, includes 40 wt. % to 90 wt. % of the polycyclohexylenedimethylene terephthalate copolymer (virgin and/or recycled).

Additionally, the stiffener core can includes about 5 wt. % to about 20 wt. % of a thermoplastic elastomer. In one instance, the stiffener core includes about 5 wt. %, 7 wt. %, 9 wt. %, 11 wt. %, 13 wt. %, 15 wt. %, 17 wt. %, 19 wt. %, or 21 wt. % of the thermoplastic elastomer. The thermoplastic elastomer can be selected from a styrene block copolymer or thermoplastic polystyrene (e.g., a styrene-butadiene block copolymer), an olefinic thermoplastic elastomer (e.g., block copolymers that include polyethylene and/or polypropylene), a copolyester, a polyamide, and a mixture thereof.

Notably, the herein described stiffener core includes a non-zero concentration of a low melting point plastic adhesive resin. That is the stiffener core composition is preferably homogeneous and includes a concentration of the low melting point plastic adhesive resin that is greater than about 2 wt. %. Preferably the stiffener core includes about 2 wt. % to about 30 wt. %, about 2 wt. % to about 25 wt. % about 2 to about 15 wt. %, or about 3 wt. % to about 10 wt. % of the low melting point plastic adhesive resin. More preferably, the stiffener core includes about 3 wt. %, 5 wt. %, 7 wt. %, 9 wt. %, 11 wt. %, 13 wt. %, 15 wt. %, 17 wt. %, 20 wt. %, 23 wt. %, 27 wt. %, or 30 wt. % of the low melting point plastic adhesive resin. In one particularly preferable example, the stiffener core includes about 6 wt. % to about 7 wt. % of the low melting point plastic adhesive resin. In another particularly preferable example, the stiffener core includes about 25 wt. % to about 28 wt. % of the low melting point plastic adhesive resin. In one example, the low melting point plastic adhesive resin is the same adhesive resin as included in the adhesive layer. In another example, the low melting point plastic adhesive resin included in the stiffener core has a different chemical composition than the adhesive resin included in the adhesive layer. Preferably, the low melting point plastic adhesive resin included in the stiffener core is a polyurethane.

The footwear stiffener can further be described or defined based on the total composition of materials in the product. In one instance, the footwear stiffener includes about 10 wt. % to about 30 wt. % of the adhesive layer carried on the stiffener core. In another instance, the footwear stiffener can include or consist of about 7 wt. % to about 30 wt. % of the low melting point plastic adhesive (inclusive of both the adhesive layer(s) and the stiffener core). In another instance, the footwear stiffener can include or consist of about 12 wt. % to about 19 wt. % of the low melting point plastic adhesive.

In yet another example, a footwear stiffener can include an adhesive layer coextruded with and carried on a stiffener core. The footwear stiffener including about 10 wt. % to about 30 wt. % of the adhesive layer where the adhesive layer includes a polyurethane having a melting point less than about 85° C., and 0 wt. % to about 5 wt. % of an antiblocking agent. The stiffener core, preferably, is an extrusion of an admixture of a polycyclohexylenedimethylene terephthalate copolymer; and a footwear stiffener recycle. The footwear stiffener recycle, preferably, includes the about 10 wt. % to about 30 wt. % of the polyurethane having a melting point less than about 85° C., about 25 wt. % to about 70 wt. % of the polycyclohexylene-dimethylene terephthalate copolymer. In a preferable example, the stiffener core includes about 2 wt. % to about 30 wt. % of the low melting point plastic adhesive resin.

Preferably, the footwear stiffener has a resiliency of about 65% to about 90%, preferably about 80% to about 90%. Furthermore, the stiffener may be evaluated to determine the adhesive bonding strength of the finished product. The adhesive bond strength is measured by die cutting a piece of the stiffener to be tested and inserting the stiffener between two pieces of a non-woven lining material that is a 35% poly ester blend having a thickness of 0.029 inches. The three pieces are held together and placed into a back part heel counter molding machine with the female mold at about 80° C. and the male mold at about 140° C. The mold is closed and held in position for 17 seconds. The mold is opened and the laminate is placed, at room temperature, in a laminate cooling station having the desired shape of the final product. The shaped heel counter is now rigid and the stiffener is bonded to the two pieces of non-woven lining material. The adhesive test requires that the three part laminate remain bonded together when manual pressure is applied to pull the components apart. This determines if the stiffening material has good adhesive qualities. The resiliency test is based on making a thumb indent on the side of the heel counter and evaluating the degree with which the indent bounces back. An acceptable bounce is when the indent bounces back immediately with a “ping-pong” sound. Another embodiment of the herein described invention is a process of manufacturing the footwear stiffener. In one instance, the process includes providing an stiffener core extruder with about 40 wt. % to about 60 wt. % of a stiffening plastic resin and about 20 wt. % to about 50 wt. % of a footwear stiffener recycle. In one instance, the materials are provided to the stiffener core extruder as chips or a powder, either via separate feeds or by premixing the materials and then adding the premix to the extruder. The footwear stiffener recycle, preferably, includes about 10 wt. % to about 30 wt. % of a low melting point thermoplastic polyurethane and about 25 wt. % to about 70 wt. % of the stiffening plastic resin. The process further includes providing an adhesive extruder with the low melting point thermoplastic polyurethane, preferably as a chip or powder. The process further includes extruding a layer of a stiffener core from the stiffener core extruder and extruding a layer of an adhesive from the adhesive extruder. Herein, the process further includes contacting the stiffener core layer and the adhesive to form a layered stiffener material. In one example, the extruder heads are positions in relative positions such that the adhesive layer is extruded onto the stiffener core layer. Preferably, the process includes calendaring the layered stiffener material. In one example, about 5 wt. % to about 15 wt. % of a thermoplastic elastomer is further provided to the stiffener core extruder. In another example, about 15 wt. % to about 30 wt. % of the low melting point thermoplastic polyurethane is further provided to the stiffener core extruder. In still another example, about 15 wt. % to about 30 wt. % of a high melting point thermoplastic polyurethane is further provided to the stiffener core extruder. As used herein, a high melting point thermoplastic polyurethane is a polyurethane resin that has a melting point greater than 100° C., 110° C., 120° C., or 130° C. In still yet another example, the process includes extruding a second layer of the low melting point plastic adhesive resin; contacting the second layer of the low melting point plastic adhesive resin with the layer of the recycled stiffener core thereby forming a recycled layered stiffener material that includes two layers of the low melting point plastic adhesive resin.

In another instance, the process includes providing an core extruder with a mixture of about 40 wt. % to about 60 wt. % of a scrap polyester and about 40 wt. % to about 60 wt. % of a scrap stiffener core. These scrap materials are preferably post-industrial scrap. The scrap polyester preferably consisting essentially of a polyester resin; yet may include percentages of agents used to facilitate the casting or extrusion of the resin prior to formation of scrap. Preferably, the scrap polyester includes at least 70 wt. %, 80 wt. %, 90 wt. %, 95 wt. %, 96 wt. %, 97 wt. %, 98 wt. % or 99 wt. % polyester resin. More preferably, the scrap polyester is a copolyester resin (e.g., a scrap copolyester resin). The scrap stiffener core preferably includes about 5 wt. % to about 20 wt. % of a thermoplastic polyurethane and about 80 wt. % to about 95 wt. % of a copolyester. Notably, the scrap stiffener core has a layered structure with a layer of the thermoplastic polyurethane carried on one or two faces of the copolyester. Preferably, both the scrap polyester resin and the scrap stiffener core are chipped or cut to provide pellets for the extruder.

The process further includes providing an adhesive extruder with a low melting point plastic adhesive resin. Preferably, the extruder is provided with the low melting point plastic adhesive resin and less than about 5 wt. % of an antiblocking agent. In one example, the extruder can be provided with a plurality of low melting point plastic adhesive resins. The (or each) low melting point plastic adhesive resin is, preferably, selected from those thermoplastic resins that have a melting point that is less than about 85° C., 80° C., 75° C., or 70° C. In one instance, the low melting point plastic adhesive resin can be a polyurethane; preferably, the low melting point plastic adhesive resin is a thermoplastic polyurethane. In another instance, the low melting point plastic adhesive resin can be selected from a polyester thermoplastic polyurethane, a polyether thermoplastic polyurethane, and a polycaprolactone thermoplastic polyurethane. In one preferable instance, the low melting point plastic adhesive resin is a polycaprolactone thermoplastic polyurethane.

The process further includes extruding a layer of a recycled stiffener core from the core extruder; extruding a layer of a the low melting point plastic adhesive resin; and contacting the layer of the recycled stiffener core and the layer of the low melting point plastic adhesive resin to form a recycled layered stiffener material. The process can further include extruding a second layer of the low melting point plastic adhesive resin; contacting the second layer of the low melting point plastic adhesive resin with the layer of the recycled stiffener core thereby forming a recycled layered stiffener material that includes two layers of the low melting point plastic adhesive resin. Lastly, the process can include calendaring the recycled layered stiffener material.

Further details of the process can be understood from the following general procedure for preparing test samples: a 2.5 inch extruder was charged with 44.5 Kg of a thermoplastic polyurethane (e.g., Taiwan Sheen Soon AH 652) that has a melting point of about 70° C. and about 0.9 Kg of an antiblocking agent; a 4 inch extruder was charged with a mixture of 50% recycled stiffener (which contains about 15 wt. % of a thermoplastic polyurethane and 85 wt. % of a copolyester), 35 wt. % of a recycled/scrap copolyester (preferably the same polyester as contained in the recycled stiffener), and 15 wt. % of a thermoplastic elastomer. The 2.5 inch extruder was operated at 89 pounds per hour and the 4 inch at 506 pounds per hour. The 2.5 inch was run at 20.2 rpm with temperatures of 115, 138, 154, 171, 188, 185° C. and the 4 inch at 506 pounds per hour at temperatures of 204, 218, 221° C. and a speed of 42 rpm. These two extruders feed a triple manifold die with the two outer layers of the die being fed by the adhesive from the 2.5 inch extruder and the center core of the die being fed by the 4 inch extruder. The outer layers of the die is maintained at a temperature of 193° C., while the center core of the die is maintained at a temperature of 221° C. The extrudate coming out of the die went into a three roll cooled calendar where a sheet of the stiffener is formed and cooled. One then has a three layer sheet material with the two outer layers consisting of the low melting point thermoplastic polyurethane and the core material consisting of the recycle stiffening materials. The core containing thermoplastic polyurethane had improved toughness and resiliency. Depending on the thickness and weight of the core material the stiffness will be increased as the weight and thickness of the core increases. The as manufactured core contained about 6-7 wt. % polyurethane.

Using the above process and materials the following stiffeners were produced. The dome testing values are a measure of stiffness with the higher value being stiffer.

| | Example | | | | |
|---|---|---|---|---|---|
| | 1 | 2 | 3 | 4 | 5 |
| Thickness, mm | 0.5 | 0.7 | 0.8 | 1.0 | 1.1 |
| Total weight, g/m2 | 648 | 835 | 935 | 1135 | 1276 |
| Adhesive layer weight | 97.2 | 97.2 | 97.2 | 97.2 | 97.2 |
| Core weight, g/m2 | 550.8 | 737.8 | 837.8 | 1037.8 | 1178.8 |
| Dome 1st collapse, kg | 1.8 | 4.0 | 5.0 | 9.0 | 12.0 |
| Dome 10^{th} collapse, kg | 1.4 | 3.0 | 4.0 | 7.0 | 8.0 |
| % Resiliency | 78 | 75 | 80 | 78 | 67 |
| % Shaper retention | 93 | 92 | 91 | 90 | 89 |

Examples 6-17 were produced by coextrusion of an adhesive layer onto a stiffener core pursuant to the following compositions and extruder settings. In these examples, adhesive layer includes about 98 wt. % of a low melting point plastic adhesive resin, here a low melting point polyurethane (e.g., AH-652). The stiffener core includes a stiffening plastic resin which in examples 6-11 is a polycyclohexylenedimethylene terephthalate copolymer (e.g., DN-011 from Eastman Chemicals) and in examples 12-17 is a polyethylene terephthalate glycol copolyester (e.g., GN-071 from Eastman Chemicals). In examples 6-8 and 12-14, the high melting point polyurethane is a thermoplastic polyurethane with a Vicat softening temperature and/or a melting temperature of greater than 92° C., preferably greater than 100° C. (e.g., ESTANE TPU from Lubrisol).

| | Adhesive | | | | | | | |
|---|---|---|---|---|---|---|---|---|
| | Layer | | | | | | | |
| | (wt. %) | Stiffener Core (wt. %) | | | | | | |
| Example | LTU | SPR | FSR | HTU | ELS | LTU | A:S | |
| 6 | 98 | 46 | 40 | 2 | 12 | | 69:391 | (15%) |
| 7 | 98 | 46 | 40 | 2 | 12 | | 123:702 | (15%) |
| 8 | 98 | 46 | 40 | 2 | 12 | | 103:581 | (15%) |
| 9 | 98 | 25 | 23 | 26 | | 26 | 133:444 | (23%) |
| 10 | 98 | 28 | 24 | 22 | | 26 | 70:235 | (23%) |
| 11 | 98 | 25 | 23 | 26 | | 26 | 84:281 | (23%) |

SPR = stiffening plastic resin (polycyclohexylenedimethylene terephthalate copolymer);
FSR = footwear stiffener recycle;
HTU = high melting point polyurethane;
ELS = elastomer;
LTU = low melting point polyurethane;
A:S = extruded adhesive layer to stiffener core run in lbs/hr (ratio of adhesive layer mass to stiffener core mass)

| Example | 6 | 7 | 8 | 9 | 10 | 11 |
|---|---|---|---|---|---|---|
| Thickness, mm | 0.56 | 0.98 | 0.81 | 0.58 | 0.34 | 0.58 |
| Total weight, g/m2 | 644 | 1106 | 925 | 624 | 372 | 621 |
| Dome 1st collapse, kg | 2.82 | 11.78 | 7.34 | 1.3 | 0.46 | 1.5 |
| Dome 10^{th} collapse, kg | 2.40 | 8.82 | 5.33 | 1.1 | 0.35 | 1.2 |
| % Resiliency | 85 | 75 | 73 | 85 | 76 | 75 |
| % Shaper retention | 93 | 91 | 92 | 93 | 92 | 93 |
| Bonding (kg/cm) | 3.9 | 5.0 | 4.3 | 5.4 | 2.3 | 4.7 |

| | Adhesive | | | | | | | |
|---|---|---|---|---|---|---|---|---|
| | Layer | | | | | | | |
| | (wt. %) | Stiffener Core (wt. %) | | | | | | |
| Example | LTU | SPR | FSR | HTU | ELS | LTU | A:S | |
| 12 | 98 | 46 | 40 | 2 | 12 | | 69:391 | (15%) |
| 13 | 98 | 46 | 40 | 2 | 12 | | 123:702 | (15%) |
| 14 | 98 | 46 | 40 | 2 | 12 | | 103:581 | (15%) |
| 15 | 98 | 25 | 23 | 26 | | 26 | 133:444 | (23%) |
| 16 | 98 | 28 | 24 | 22 | | 26 | 70:235 | (23%) |
| 17 | 98 | 25 | 23 | 26 | | 26 | 84:281 | (23%) |

SPR = stiffening plastic resin (polyethylene terephthalate glycol copolyester);
FSR = footwear stiffener recycle;
HTU = high melting point polyurethane;
ELS = elastomer;
LTU = low melting point polyurethane;
A:S = extruded adhesive layer to stiffener core run in lbs/hr (ratio of adhesive layer mass to stiffener core mass)

| Example | 12 | 13 | 14 | 15 | 16 | 17 |
|---|---|---|---|---|---|---|
| Thickness, mm | 0.56 | 0.98 | 0.80 | 0.57 | 0.33 | 0.55 |
| Total weight, g/m2 | 635 | 1106 | 934 | 629 | 374 | 610 |
| Dome 1st collapse, kg | 2.85 | 11.81 | 7.50 | 1.4 | 0.47 | 1.4 |
| Dome 10^{th} collapse, kg | 2.39 | 8.73 | 5.42 | 1.2 | 0.36 | 1.2 |
| % Resiliency | 84 | 74 | 72 | 84 | 77 | 80 |
| % Shaper retention | 93 | 91 | 92 | 92 | 92 | 93 |
| Bonding (kg/cm) | 4.3 | 4.5 | 4.4 | 5.8 | 3.8 | 3.6 |

Notably, compositions 18-19 were produced and tested to compare the effects of utilizing the polycyclohexylenedimethylene terephthalate copolymer in place of the polyethylene terephthalate glycol copolyester. Notably, the use of the polycyclohexylenedimethylene terephthalate copolymer significantly decreased performance of the footwear stiffener in both collapse and bonding results.

| | Adhesive | | | | | | | |
|---|---|---|---|---|---|---|---|---|
| | Layer | | | | | | | |
| | (wt. %) | Stiffener Core (wt. %) | | | | | | |
| Example | LTU | SPR | FSR | HTU | ELS | LTU | A:S | |
| 18 | 98 | 86 | 0 | 0 | 14 | | 98:556 | (15%) |
| | | where SPR = polyethylene terephthalate glycol | | | | | | |
| | | copolyester | | | | | | |
| 19 | 98 | 86 | 0 | 0 | 14 | | 98:556 | (15%) |

where SPR = polycyclohexylenedimethylene
terephthalate copolymer

| | Example | | |
|---|---|---|---|
| | 18 | 19 | % Change |
| Thickness, mm | 1.1 | 1.1 | 0 |
| Total weight, g/m2 | 1270 | 1251 | −1.5 |
| Dome 1st collapse, kg | 19.4 | 15.7 | −19.0 |
| Dome 10^{th} collapse, kg | 15.0 | 12.3 | −17.6 |
| % Resiliency | 77 | 78 | 1.2 |
| % Shaper retention | 92 | 91 | −1.0 |
| Bonding (kg/cm) | 5.6 | 2.4 | −56 |

While specific embodiments are illustrated in the examples, with the understanding that the disclosure is intended to be illustrative, these embodiments are not intended to expressly limit the invention described and illustrated herein.

What is claimed:

1. A footwear stiffener comprising:
an adhesive layer coextruded with and carried on a stiffener core;
the footwear stiffener including about 10 wt. % to about 30 wt. % of the adhesive layer;
the adhesive layer comprising a low melting point plastic adhesive resin and less than about 5 wt. % of an antiblocking agent;
the stiffener core comprising an admixture of a stiffening plastic resin and a footwear stiffener recycle; wherein the stiffener core includes about 2 wt. % to about 30 wt. % of the low melting point plastic adhesive resin.

2. The footwear stiffener of claim 1, wherein the adhesive layer consists essentially of the low melting point plastic adhesive resin and the antiblocking agent; and wherein the low melting point plastic adhesive resin is a polyurethane having a melting point less than about 85° C.

3. The footwear stiffener of claim 1, wherein the adhesive layer comprises a plurality of low melting point plastic adhesive resins.

4. The footwear stiffener of claim 1, wherein the stiffening plastic resin is selected from a polyethylene terephthalate, a styrene, styrene-butadiene, a vinyl acetate, a vinyl chloride, an acrylic, a polyvinyl chloride, a polyethylene, a polypropylene, a polyester, a polystyrene, a copolymer thereof, and a mixture thereof.

5. The footwear stiffener of claim 1, wherein the stiffening plastic resin is a polycyclohexylenedimethylene terephthalate copolymer.

6. The footwear stiffener of claim 1, wherein the footwear stiffener recycle includes about 10 wt. % to about 30 wt. % of an adhesive layer which includes the low melting point plastic adhesive resin and less than about 5 wt. % of the antiblocking agent; and about 70 wt. % to about 90 wt. % of a recycle stiffener core that includes 40 wt. % to 90 wt. % of a polycyclohexylenedimethylene terephthalate copolymer.

7. The footwear stiffener of claim 6, wherein the stiffening plastic resin is a polycyclohexylenedimethylene terephthalate copolymer.

8. The footwear stiffener of claim 1, wherein the stiffener core further includes about 5 wt. % to about 20 wt. % of a thermoplastic elastomer.

9. The footwear stiffener of claim 1 further comprising a continuous, non-zero, concentration of the low melting point plastic adhesive resin from a first major surface carried by the adhesive layer through the stiffener core to a second major surface; where the continuous concentration of the low melting point plastic adhesive resin is greater than about 2 wt. %.

10. The footwear stiffener of claim 1, wherein the stiffener core consists of admixture of the stiffening plastic resin, the footwear stiffener recycle, a high melting point polyurethane, and, optionally, an elastomer

11. A footwear stiffener comprising:
an adhesive layer coextruded with and carried on a stiffener core;
the footwear stiffener including about 10 wt. % to about 30 wt. % of the adhesive layer;
the adhesive layer including a polyurethane having a melting point less than about 85° C., and 0 wt. % to about 5 wt. % of an antiblocking agent;
the stiffener core comprising an extrusion of
an admixture of a polycyclohexylenedimethylene terephthalate copolymer; and
a footwear stiffener recycle that includes about 10 wt. % to about 30 wt. % of the polyurethane having a melting point less than about 85° C., and about 25 wt. % to about 70 wt. % of the polycyclohexylenedimethylene terephthalate copolymer;
wherein the stiffener core includes about 2 wt. % to about 30 wt. % of the low melting point plastic adhesive resin.

12. A process of manufacturing a footwear stiffener comprising:
providing an stiffener core extruder with
about 40 wt. % to about 60 wt. % of a stiffening plastic resin and
about 20 wt. % to about 50 wt. % of a footwear stiffener recycle that includes about 10 wt. % to about 30 wt. % of a low melting point thermoplastic polyurethane and about 25 wt. % to about 70 wt. % of the stiffening plastic resin;
providing an adhesive extruder with the low melting point thermoplastic polyurethane;
extruding a layer of a stiffener core from the stiffener core extruder;
extruding a layer of an adhesive from the adhesive extruder;
contacting the stiffener core layer and the adhesive to form a layered stiffener material; and then
calendaring the layered stiffener material.

13. The process of claim 12, wherein about 5 wt. % to about 15 wt,% of a thermoplastic elastomer is further provided to the stiffener core extruder.

14. The process of claim 12, wherein about 15 wt. % to about 30 wt. % of the low melting point thermoplastic polyurethane is further provided to the stiffener core extruder.

15. The process of claim 12, wherein about 15 wt. % to about 30 wt. % of a high melting point thermoplastic polyurethane is further provided to the stiffener core extruder.

16. The process of claim 12 further comprising extruding a second layer of the low melting point plastic adhesive resin; contacting the second layer of the low melting point plastic adhesive resin with the layer of the recycled stiffener core thereby forming a recycled layered stiffener material that includes two layers of the low melting point plastic adhesive resin.
